(19) United States
(12) Patent Application Publication
(10) Pub. No.: US 2005/0068628 A1
(43) Pub. Date: Mar. 31, 2005

(54) Optical sheet and backlight unit using the same

(75) Inventor: Hitoshi Masaki, Tokyo (JP)

Correspondence Address: JORDAN AND HAMBURG LLP, 122 EAST 42ND STREET, SUITE 4000, NEW YORK, NY, 10168, US

(73) Assignee: KEIWA INC., Osaka-shi (JP)

(21) Appl. No.: 10/950,723

(22) Filed: Sep. 27, 2004

(30) Foreign Application Priority Data
Sep. 30, 2003 (JP) 2003-339737

(51) Int. Cl. G03G 15/04; G02B 5/02; G02B 13/20

(52) U.S. Cl. 359/599

(57) ABSTRACT

An object of the present invention is to provide optical sheets having excellent heat resistance, moisture resistance, thermal dimensional stability and weather resistance, which hardly give rise to bending, yellowing and the like even though they receive generated heat from a lamp and ultraviolet ray irradiation, and to provide backlight units in which reduction of the occurrence of lack in uniformity of the brightness and lowering of the brightness is achieved using the optical sheet. The optical sheet of the present invention has a transparent substrate layer, and an optical layer overlaid to the front face side of the substrate layer. This optical layer includes a light diffusing agent in the binder. This binder is formed from a polymer composition containing (A) a copolymer and (B) a fine inorganic filler. This copolymer (A) includes at least one of a recurring unit derived from a (meth)acrylic ester having a cycloalkyl group, a recurring unit derived from an iso-butyl (meth)acrylate or a recurring unit derived from a tert-butyl (meth)acrylate.

### BACKGROUND OF THE INVENTION

1. Field of the Invention

The present invention relates to optical sheets predominantly having a function to diffuse transmitted rays of light (light diffusion function), which are suitable for a backlight of a liquid crystal display device, in particular, and backlight units in which this optical sheet is used.

2. Description of the Related Art

Liquid crystal display devices in widespread use have been in a backlight system where light emission is executed by irradiating onto a liquid crystal layer from the back face. In such a type of a display device, a backlight unit which is an edge light type, an immediate beneath type or the like is provided to an under face side of the liquid crystal layer. Such a backlight unit 20 of an edge light type is generally equipped with a rod-shaped lamp 21 for use as a light source, an optical waveguide plate 22 having a square plate shape disposed so that the edge thereof abuts along the lamp 21, a light diffusion sheet 23 disposed to the front face side of the optical waveguide plate 22, and a prism sheet 24 disposed to the front face side of the light diffusion sheet 23, essentially as shown in FIG. 3(a).

Referring to functions of this backlight unit 20, rays of incident light from the lamp 21 to the optical waveguide plate 22 are first reflected on reflection dots or a reflection sheet (not shown in the Figure) of the back face of the waveguide plate 22, and exit from the front face of the waveguide plate 22. The rays of light exited from the waveguide plate 22 enter into the light diffusion sheet 23, then are diffused by the light diffusion sheet 23 and exit from the front face of the light diffusion sheet 23. Thereafter, the rays of light exited from the light diffusion sheet 23 enter into the prism sheet 24, and exit as rays of light having a distribution representing a peak in a direction along a substantially normal line via a prism part 24a formed on the front face of the prism sheet 24.

Accordingly, the rays of light that exited from the lamp 21 are diffused by the light diffusion sheet 23, and refracted by the prism sheet 24 so that they represent a peak in a direction along the substantially normal line, and illuminate the entire face of the liquid crystal layer on the front face side (not shown in the Figure). Meanwhile, although not shown in the Figure, an additional light diffusion sheet having a comparatively low light diffusion function may be also disposed to the front face side of the prism sheet 24 for the purpose of: relaxation of light condensing properties of the prism sheet 24 as described above; protection of the prism part 24a; or prevention of the sticking between the prism sheet 24 and the liquid crystal panel such as a polarization plate. The light diffusion sheet, prism sheet and other anti-glare sheet and the like having 1 or 2 or more optical functions (various functions such as light diffusion, light condensing, refraction and the like) are referred to as an optical sheet.

The light diffusion sheet 23 to be disposed to the backlight unit 20 generally has a transparent substrate layer 26 made of a synthetic resin, a light diffusion layer 27 overlaid on the front face of the substrate layer 26, and a sticking preventive layer 28 overlaid on the back face of the substrate layer 26 as shown in FIG. 3(b). In general, this light diffusion layer 27 includes a light diffusing agent 30 in a binder 29, and thus a function to diffuse transmitted rays of light is ensured by the light diffusing agent 30. Further, the sticking preventive layer 28 includes a small amount of beads 32 dispersed in a binder 31 spacing apart one another, and has a structure with lower parts of these beads 32 projecting from the back face of the binder 31. Accordingly, disadvantages of the occurrence of interference fringes through close contact of the back face of the light diffusion sheet 23 with the front face of the waveguide plate 22 are prohibited.

In the backlight unit 20 as described above, the lamp 21 which is a source for generating rays of light generates heat in concurrence with light emission, therefore, a proximal part to the lamp 21 out of the light diffusion sheet 23 is exposed to the temperature of around 80° C. to 90° C. On the other hand, since the light diffusion sheet 23 is generally formed from a synthetic resin, there exist primary disadvantages of being susceptive to deformation and discoloration (yellowing and the like) by heat, ultraviolet ray and the like. Thus, the light diffusion sheet 23 partially bends under a high temperature, consequently leading to disadvantages of occurrence of lack in uniformity of the brightness of a display window.

In an attempt to overcome such disadvantages, techniques have been developed contemplating the improvement of heat resistance by including a dispersed fine inorganic filler within the binder 29 of the light diffusion layer 27 in the light diffusion sheet 23 (for example, see, JP-A-1995-5305, JP-A-2000-89007 and the like).

The aforementioned technique to include a dispersed fine inorganic filler within a conventional binder 29 is effective in improving heat resistance of the light diffusion sheet 23, however, increase in content of the fine inorganic filler may bring about deterioration of transmittance of the entire rays of light and directional diffusing function (function to diffuse transmitted rays of light while condensing the light and varying the angle in a normal line direction). Therefore, the technique is not satisfactory for preventing thermal deformation in the backlight unit 20 without inhibiting the transmittance of rays of light and directional diffusing function.

### SUMMARY OF THE INVENTION

The present invention was accomplished taking into account of such disadvantages, and an object of the present invention is to provide an optical sheet having excellent heat resistance, moisture resistance, thermal dimensional stability, weather resistanceand the like, which hardly gives rise to bending, yellowing and the like even though it receives generated heat from the lamp and ultraviolet ray irradiation; and a backlight unit in which reduction of the occurrence of lack in uniformity of the brightness and lowering of the brightness is achieved using such an optical diffusion sheet.

Accordingly, the present inventor investigated on causes for occurrence of partial bending of the light diffusion sheet in the backlight unit, and consequently found that not only heat of the lamp, but also moisture is responsible for the occurrence. More specifically, as the moisture resistance of the light diffusion sheet is reduced, heat-induced bending in the backlight unit is liable to occur. Similar event is also found in a variety of optical sheets other than light diffusion sheets.

The optical sheet according to the present invention which was consequently accomplished in order to solve the problems described above comprises a transparent substrate layer, and an optical layer overlaid to the front face side of this substrate layer,
wherein the optical layer comprises a binder,
the binder is formed from a polymer composition comprising (A) a copolymer and (B) a fine inorganic filler, and
the copolymer (A) comprises at least one of a recurring unit derived from a (meth)acrylic ester having a cycloalkyl group, a recurring unit derived from an iso-butyl (meth)acrylate or a recurring unit derived from a tert-butyl (meth)acrylate.

The optical sheet has improved heat resistance on behalf of the fine inorganic filler (B) included in the binder of the optical layer. Furthermore, according to the optical sheet, the copolymer (A) constituting the binder of the optical layer includes a cycloalkyl group, an iso-butyl group or a tert-butyl group, and thus, it is speculated that moisture resistance is improved by the functional group having high hydrophobicity. As a result, occurrence of bending of the optical sheet at high temperature and high humidity can be dramatically suppressed by heat resistance due to the aforementioned fine inorganic filler (B), in cooperation with moisture resistance due to the aforementioned copolymer (A). Moreover, the copolymer (A) includes the aforementioned functional group in the optical sheet, leading to effective elevation of the glass transition temperature (Tg) of the copolymer (A), thereby improving hardness of the optical layer, which is speculated to be responsible for the improvement of the heat resistance also in this respect. In addition, use of the aforementioned copolymer (A) as a substrate polymer of the binder in the optical layer according to the optical sheet also improves performances of the coated film such as ultraviolet ray resistance, weather resistance, transparency, surface smoothness, solvent resistance and the like. Therefore, the optical sheet comprising a light disusing agent in the aforementioned binder can have great heat resistance, thermal dimensional stability, weather resistance and the like, as well as an excellent light diffusion function.

As explained hereinabove, the optical sheet of the present invention enables improvement of heat resistance, moisture resistance, thermal dimensional stability, weather resistance and the like while keeping excellent optical functions such as transmittance of the entire rays of light, the directional diffusing function and the like. Also, occurrence of bending, yellowing and the like resulting from generated heat from the lamp and radiation of ultraviolet rays can be suppressed. Further, the backlight unit having such an optical sheet can drastically reduce occurrence of lack in uniformity of the brightness and lowering of the brightness.

### BRIEF DESCRIPTION OF THE DRAWINGS

FIG. 1 is a schematic cross sectional view illustrating an optical sheet according to one embodiment of the present invention.

FIG. 2 is a schematic cross sectional view illustrating an optical sheet having different constitution from that shown in FIG. 1.

FIG. 3(a) is a schematic perspective view illustrating a common backlight unit of an edge light type.

FIG. 3(b) is a schematic cross sectional view illustrating a common light diffusion sheet.

### DESCRIPTION OF THE PREFERRED EMBODIMENTS

Embodiments of the present invention are described in detail below with reference to the figures ad libitum.

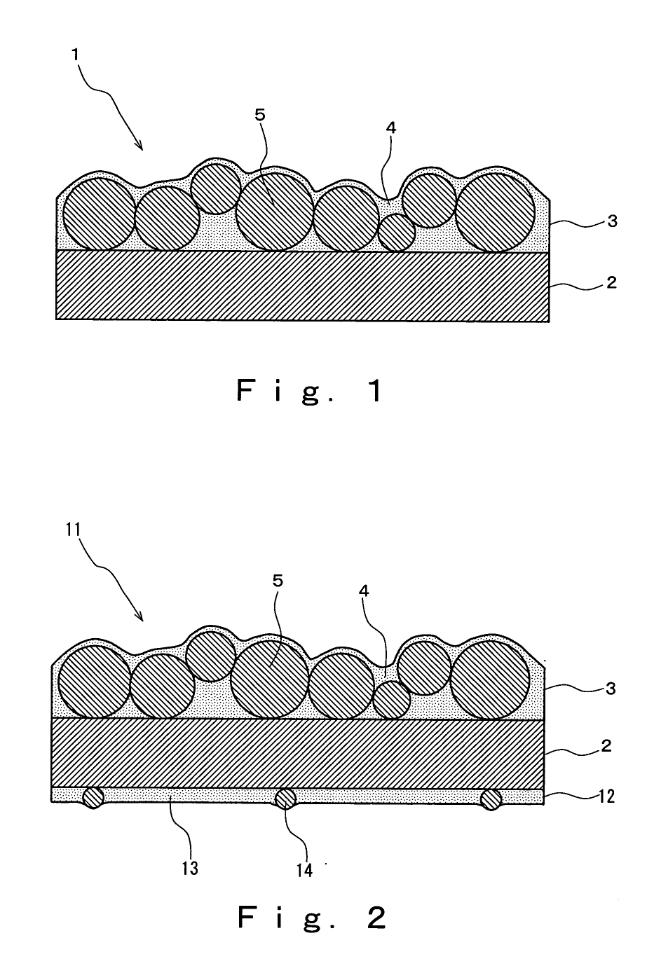

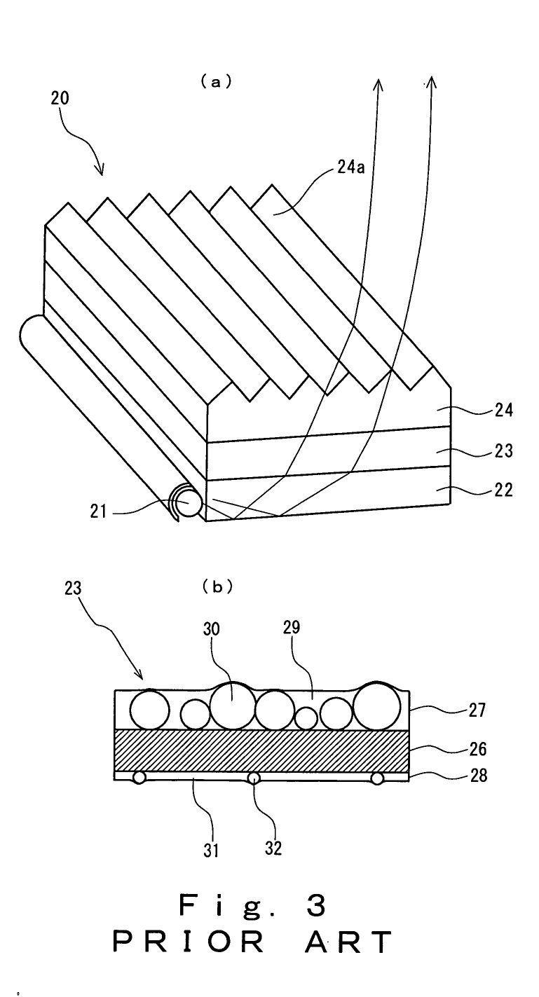

The optical sheet 1 shown in FIG. 1 is similar to a light diffusion sheet, and comprises a substrate layer 2, and an optical layer 3 overlaid on the front face of this substrate layer 2.

The substrate layer 2 is formed from a transparent, particularly colorless transparent, synthetic resin, because transmission of rays of light is required. The synthetic resin which can be used for the substrate layer 2 is not particularly limited, but examples thereof include e.g., polyethylene terephthalate, polyethylene naphthalate, acrylic resins, polycarbonate, polystyrene, polyolefin, cellulose acetate, weather resistant vinyl chloride, and the like. Among them, polyethylene terephthalate having excellent transparency and high strength is preferred, and polyethylene terephthalate with improved bending property is particularly preferred.

Although the thickness of the substrate layer 2 (mean thickness) is not particularly limited, it may be for example, equal to or greater than 10 μm and equal to or less than 500 μm, preferably equal to or greater than 35 μm and equal to or less than 250 μm, and particularly preferably equal to or greater than 50 μm and equal to or less than 188 μm. When the thickness of the substrate layer 2 is less then the above range, disadvantages are raised such as liability to occurrence of the curling upon coating of the resin composition for forming the optical layer 3, and difficulties in handling thereof. To the contrary, when the thickness of the substrate layer 2 is greater than the above range, brightness of a liquid crystal display device may be lowered, and the thickness of a backlight unit becomes so large that a result that is adverse to demands for thin modeling of a liquid crystal display device may be also effected.

The optical layer 3 comprises a light diffusing agent 5 disposed to form layers with substantially even density on the front face of the substrate layer 2, and a binder 4 filled around this light diffusing agent 5. By including the light diffusing agent 5 in the optical layer 3 in such a manner, rays of light which transmit the optical sheet 1 from the back side to the front side can be uniformly diffused. Moreover, fine protrusions are formed with the light diffusing agent 5 on the surface of the optical layer 3 in a substantially uniform manner. On behalf of a refracting action of the fine protrusion like a lens on the front face of the optical sheet 1, the transmitted rays of light can be more efficiently diffused. Although the thickness of the optical layer 3 is not particularly limited, it may be for example, equal to or greater than 5 μm and equal to or less than 30 μm, and preferably equal to or greater than 8 μm and equal to or less than 15 μm.

The light diffusing agent 5 is particles having a property to permit diffusion of rays of light, which may be generally classified into inorganic fillers and organic fillers. Specific examples of the inorganic filler include silica, aluminum hydroxide, aluminum oxide, zinc oxide, barium sulfate, magnesium silicate, or mixtures thereof. Specific materials of the organic filler which may be used include acrylic resins, acrylonitrile resins, polyurethane, polyvinyl chloride, polystyrene, polyacrylonitrile, polyamide and the like. Among them, acrylic resins having high transparency are preferred, and in particular, polymethyl methacrylate (PMMA) is preferred which may be used alone or included as a principal component.

Shape of the light diffusing agent 5 is not particularly limited, but may be for example, spherical, cubic, needle-like, rod-like, spindle, discal, squamous, fibrous and the like. Among them, spherical beads that are excellent in a light diffusing property are preferred.

Lower limit of the mean particle size of the light diffusing agent 5 is preferably 1 μm, particularly preferably 2 μm, and even more preferably 5 μm. Upper limit of the mean particle size of the light diffusing agent 5 is preferably 50 μm, particularly preferably 20 μm, and even more preferably 15 μm. When the mean particle size of the light diffusing agent 5 is less than the above range, less recessions and protrusions on the surface of the optical layer 3 formed by the light diffusing agent 5 are provided, involving the probability of unsatisfactory light diffusing property required for a light diffusion sheet. To the contrary, when the mean particle size of the light diffusing agent 5 is greater than the above range, the thickness of the optical sheet 5 is increased, and uniform diffusion may be difficult.

Lower limit of the amount of the light diffusing agent 5 to be blended (amount to be blended which is calculated on the basis of the solid content per 100 parts of the base polymer content in the polymer composition that is a formative material of the binder 4) is preferably 10 parts, particularly preferably 20 parts, and even more preferably 50 parts. Upper limit of this amount to be blended is preferably 500 parts, particularly preferably 300 parts, and even more preferably 200 parts. When the amount of the light diffusing agent 5 to be blended is less than the above range, light diffusing property may become insufficient, while when the amount of the light diffusing agent 5 to be blended is beyond the above range, effects of fixing the light diffusing agent 5 may be reduced. In the instances of use as a so-called light diffusion sheet for upper use which is disposed to the front face side of a prism sheet, it is preferred that the amount of the light diffusing agent 5 to be blended is 10 parts or greater and 40 parts or less, and particularly 10 parts or greater and 30 parts or less because high light diffusing property is not required. The value represented by “part” means a proportion on the basis of the weight.

The binder 4 can be formed by allowing a polymer composition to be cured. This polymer composition contains (A) a copolymer and (B) a fine inorganic filler. The binder 4 is to be transparent, particularly preferably colorless and transparent, because transmission of rays of light is required.

The copolymer (A) comprises at least one of a recurring unit derived from a (meth)acrylic ester having a cycloalkyl group, a recurring unit derived from an iso-butyl (meth)acrylate or a recurring unit derived from a tert-butyl (meth)acrylate.

The recurring unit derived from a (meth)acrylic ester having a cycloalkyl group (hereinafter, may be also referred to as “cycloalkyl-containing recurring unit”) means a recurring unit obtained when polymerization is executed using a (meth)acrylic ester having at least one cycloalkyl group, as a monomer. When the copolymer including such a cycloalkyl-containing recurring unit is used, moisture resistance, hardness and the like of the optical sheet 1 can be improved, and consequently, it is responsible for improvement of the heat resistance of the optical sheet 1.

Examples of this cycloalkyl-containing recurring unit include recurring units represented by the following chemical formula (1), which can more efficiently improve the moisture resistance, heat resistance, hardness and the like of the optical sheet 1.

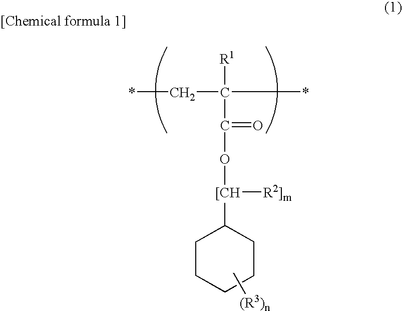

In the above chemical formula (1), R¹ is a hydrogen atom or a methyl group. R² is a hydrogen atom, a methyl group or an ethyl group. R³ is an organic residue which directly binds to the cycloalkyl group shown in the chemical formula (1). Examples of this organic residue include e.g., straight-chain, branched or cyclic alkyl groups having from 1 to 10 carbon atoms, hydroxyalkyl groups having from 1 to 5 carbon atoms, alkoxyalkyl groups having from 1 to 5 carbon atoms, acetoxyalkyl groups having from 1 to 5 carbon atoms, halogenated (for example, chlorinated, brominated or fluorinated) alkyl groups having from 1 to 5 carbon atoms, and the like. Among them, alkyl groups having from 1 to 4 carbon atoms, hydroxyalkyl group having from 1 to 2 carbon atoms, alkoxyalkyl group having from 1 to 2 carbon atoms, acetoxyalkyl groups having from 1 to 2 carbon atoms, are suitably used.

Examples of the aforementioned straight-chain, branched or cyclic alkyl groups having from 1 to 10 carbon atoms include a methyl group, an ethyl group, a n-propyl group, an iso-propyl group, a n-butyl group, an iso-butyl group, a tert-butyl group, a pentyl group, a hexyl group, a cyclohexyl group, a heptyl group, an octyl group, a nonyl group, a decyl group and the like. Examples of the hydroxyalkyl group having from 1 to 5 carbon atoms include a hydroxymethyl group, a 1-hydroxyethyl group, a 2-hydroxyethyl group, a 3-hydroxypropyl group and the like. Examples of the alkoxyalkyl group having from 1 to 5 carbon atoms include a methoxymethyl group, an ethoxymethyl group, a 1-methoxymethyl group, a 2-methoxyethyl group and the like. Examples of the acetoxyalkyl group having from 0.1 to 5 carbon atoms include an acetoxymethyl group, a 1-acetoxyethyl group, a 2-acetoxyethyl group, a 3-acetoxypropyl group and the like. Examples of the halogenated alkyl group having from 1 to 5 carbon atoms include a trifluoromethyl group, a trichloromethyl group, a tribromomethyl group, a 1-fluoroethyl group, a 1,1-difluoroethyl group and the like.

In the above chemical formula (1), m is an integer number of 0 or greater and 4 or less, and n is an integer number of 0 or greater and 2 or less. When m is equal to or greater than 2, R² may be the same or different. When n is equal to or greater than 2, R³ may be the same or different, and also, a ring may be formed with a plural number of R³ For example, a ring may be formed with two existing R³, and the cycloalkyl group moiety shown in the chemical formula (1) may be an isobornyl group. Binding site of R³ to the cycloalkyl group is not particularly limited. When n is equal to or greater than 1, one of R³ preferably binds to position 3 or position 4 of the cycloalkyl group. Absence of any substituent on the cycloalkyl group is acceptable, in other words, n may be 0.

The cycloalkyl-containing recurring unit represented by the above chemical formula (1) can be formed from a monomer such as cyclohexyl (meth)acrylate, cyclohexylmethyl (meth)acrylate, cyclohexylethyl (meth)acrylate, cyclohexylpropyl (meth)acrylate, cyclohexylbutyl (meth)acrylate, 4-methylcyclohexylmethyl (meth)acrylate, 4-ethylcyclohexylmethyl (meth)acrylate, isobornyl (meth)acrylate, 4-hydroxymethylcyclohexylmethyl (meth)acrylate or the like. However, the monomer for use in forming the cycloalkyl group-containing monomer unit is not limited thereto. Among the illustrated monomers, cyclohexyl (meth)acrylate, cyclohexylmethyl (meth)acrylate or 4-methylcyclohexylmethyl (meth)acrylate is suitably used. In other words, in the preferred recurring unit represented by the chemical formula (1), R¹ is a hydrogen atom or a methyl group; R² is a hydrogen atom; R³ is a methyl group; m is 0 or 1; and n is 0 or 1.

The recurring unit derived from an iso-butyl (meth)acrylate means a recurring unit represented by [—CH₂—CH(COOCH₂CH(CH₃)₂)—] or [—CH₂—C(CH₃) (COOCH₂CH(CH₃)₂)—]. When the copolymer including a recurring unit derived from an iso-butyl (meth)acrylate is used, moisture resistance, heat resistance, hardness and the like of the optical sheet 1 can be improved.

Examples of the recurring unit derived from a tert-butyl (meth)acrylate means a recurring unit represented by [—CH₂—CH (COOC(CH₃)₃)—] or [—CH₂—C(CH₃) (COOC(CH₃)₃)—]1. When the copolymer including a recurring unit derived from a tert-butyl (meth)acrylate is used, moisture resistance, heat resistance, hardness and the like of the optical sheet 1 can be improved.

The copolymer (A) may include other recurring unit. Examples of the monomer which may be used for synthesizing the copolymer (A) including such other recurring unit include polymerizable unsaturated monomers having a carboxyl group such as (meth)acrylic acid, maleic acid, maleic anhydride and the like; (meth)acrylic acid alkyl esters such as methyl (meth)acrylate, ethyl (meth)acrylate, propyl (meth)acrylate, iso-propyl (meth)acrylate, n-butyl (meth)acrylate, 2-ethylhexyl (meth)acrylate, lauryl (meth)acrylate, stearyl (meth)acrylate and the like; polymerizable unsaturated monomers having a hydroxyl group such as 2-hydroxyethyl (meth)acrylate, 4-hydroxybutyl (meth)acrylate, caprolactone-modified hydroxy (meth)acrylate and the like; polymerizable unsaturated monomers having a sulfonic acid group such as vinylsulfonic acid, styrenesulfonic acid, sulfoethyl (meth)acrylate and the like; acidic phosphoric acid ester-based polymerizable unsaturated monomers such as 2-(meth)acryloyloxyethyl acid phosphate, 2-(meth)acryloyloxypropyl acid phosphate, 2-methacryloyloxyethylphenyl phosphate and the like; polymerizable unsaturated monomers having an epoxy group such as glycidyl (meth)acrylate and the like; polymerizable unsaturated monomers having a nitrogen atom such as (meth)acrylamide, N,N′-dimethylaminoethyl (meth)acrylate and the like; polymerizable unsaturated monomers having a halogen atom such as vinyl chloride, vinylidene chloride and the like; aromatic polymerizable unsaturated monomers such as styrene, α-methylstyrene, vinyltoluene and the like; vinyl esters such as vinyl acetate; vinyl ether; unsaturated cyanogens compounds such as (meth)acrylonitrile and the like. The monomer and the amount thereof may be determined taking into account of the characteristics such as heat resistance, translucency, hardness and the like which may be desired for the optical sheet 1.

Content of each recurring unit in the copolymer (A) is not particularly limited. However, total content of the cycloalkyl-containing recurring unit, recurring unit derived from an iso-butyl (meth)acrylate and a recurring unit derived from a tert-butyl (meth)acrylate in the copolymer (A) is preferably 5% by weight or greater and 98% by weight or less, and particularly preferably 30% by weight or greater and 80% by weight or less per the polymerizable unsaturated monomer, in order to efficiently prevent the optical sheet 1 from bending.

Number average molecular weight of the copolymer (A) is preferably 1000 or greater and 50000 or less, and particularly preferably 3000 or greater 10000 or less. By setting the number average molecular weight of the copolymer (A) to fall within the above range, hydrophobicity and other physical properties of the coated film by the aforementioned binder 4 can be efficiently improved.

Process for producing the copolymer (A) is not particularly limited. An appropriate process may be selected in compliance with the type of the monomer to be polymerized and conditions of the operation. For example, the process described in the following Example may be applied. As the case may be, a commercially available copolymer (A) may be also used.

Content of the copolymer (A) in the polymer composition is not also particularly limited. The content of the copolymer (A) may be determined in light of operation properties, conditions of operation, physical properties of the copolymer (A) and the like. For example, when reduction of the viscosity of the polymer composition is intended, content of the solvent may be elevated to relatively reduce the content of the polymer (A).

The fine inorganic filler (B) is fine particles of an inorganic matter which is constituted from an arbitrary element. Through including the dispersed fine inorganic filler (B) into the binder 4, heat resistance of the optical sheet 1 is improved. The inorganic matter which constitutes the fine inorganic filler (B) is not particularly limited, but inorganic oxide is preferred. This “inorganic oxide” is defined as an oxygen-containing metal compound in which metal elements are bound to form a three dimensional network predominantly via an oxygen atom. This “metal element” involves silicon. The metal element that constitutes the inorganic oxide is preferably an element selected from the groups II to VI in a periodic table of the elements, and more preferably an element selected from the groups III to V in a periodic table of the elements. Among them, an element selected from the group consisting of Si, Al, Ti and Zr is particularly preferred, and colloidal silica in which the metal element is Si is most preferred in light of the effect of improving the heat resistance and the transmittance of rays of light. This colloidal silica can be comparatively readily produced, and is inexpensive. The fine inorganic filler (B) may be produced according to the procedure described in the following Example, or alternatively, commercially available product may be used.

Shape of the fine inorganic filler (B) is not particularly limited, but may be an optional particle shape such as spherical, needle-like, plate-like, squamous, granular or the like. Furthermore, two or more kinds of the fine inorganic fillers (B) may be used in combination.

Lower limit of the mean particle size of the fine inorganic filler (B) is preferably 5 nm, and particularly preferably 10 nm. On the other hand, upper limit of the mean particle size of the fine inorganic filler (B) is preferably 200 nm, and particularly preferably 50 nm. When the mean particle size of the fine inorganic filler (B) is less than the range described above, surface energy of the fine inorganic filler (B) becomes too high, and thus aggregation or the like becomes liable to occur. To the contrary, when the mean particle size of the fine inorganic filler (B) is greater than the range described above, there is the possibility of failure to completely maintain the transparency of the optical sheet 1. The “mean particle size” herein means volume average particle size, which can be measured by any of known means for measurement, for example, means described in the following Example.

Coefficient of variation of the particle size of the fine inorganic filler (B) is preferably equal to or less than 50%, and particularly preferably equal to or less than 30%. When the coefficient of variation of the particle size of the fine inorganic filler (B) is beyond the above range, the surface of the binder 4 of the optical layer 3 loses smoothness, which may result in reduction of transmittance of the entire rays of light. The term “coefficient of variation of particle size” herein is defined as a value obtained by dividing standard deviation of the particle size by the mean particle size. This coefficient of variation is measured according to, for example, the method described in the following Example.

Lower limit of the content of the fine inorganic filler (B) in the polymer composition (calculated on the basis of the solid content) is preferably 10% by weight, and particularly preferably 25% by weight. On the other hand, upper limit of the content of the fine inorganic filler (B) is preferably 70% by weight, and particularly preferably 50% by weight. When the content of the fine inorganic filler (B) is less than the range described above, thermal deformation of the optical sheet 1 may not be sufficiently prevented. To the contrary, when the content thereof is greater than the range described above, blending the inorganic filler into the polymer composition turns to be difficult, and light transmittance of the optical layer 3 could be lowered.

Composite fine particles formed by fixing an organic polymer on the surface of the fine inorganic filler (B) may be used. By using such composite fine particles, dispersion property in the binder 4 and affinity with the binder 4 may be improved. As a result, an optical layer 3 having favorable physical properties of the coated film such as surface hardness, heat resistance, abrasion resistance, weather resistance, stain resistance and the like can be formed, and eventually, light transmittance, heat resistance, strength and the like of the optical sheet 1 can be improved. The term “fix” herein does not mean mere adhesion and attachment, but means formation of a chemical binding between the organic polymer and the surface of the fine inorganic filler (B) that is a core. Therefore, even though the composite fine particles are washed with a cleaning fluid, the organic polymer is not substantially detected in the washing.

In regard to this organic polymer, molecular weight, shape, constitution, presence or absence of the functional group, and the like are not particularly limited, but any optional organic polymer can be used. In addition, the organic polymer which can be used may be in an optional shape such as straight-chain, branched, crosslinked structure and the like.

Specific examples of the resin that constitutes the organic polymer include e.g., (meth)acrylic resins, polystyrene, vinyl polyacetate, polyolefin such as polyethylene, polypropylene and the like, polyesters such as polyvinyl chloride, polyvinylidene chloride, polyethylene terephthalate and the like, and copolymers thereof, as well as partially modified resins thereof with a functional group such as an amino group, an epoxy group, a hydroxyl group, a carboxyl group or the like. Among them, resins comprising an organic polymer including a (meth)acrylic unit as an essential ingredient, such as (meth)acrylic resins, (meth)acryl-styrene resins, (meth)acryl-polyester resins are suitable because they have potency to form a coated film. On the other hand, resins having compatibility with the copolymer (A) that is a base polymer for the polymer composition described above are preferred. Accordingly, the most preferred is a resin having the same constitution with the copolymer (A).

Exemplary means for integrating the organic polymer and the fine inorganic filler (B) as a core in the aforementioned composite fine particle include (a) a method in which the organic polymer is fixed on the surface of the particle of the fine inorganic filler (B); and (b) a method in which integration with the organic polymer is achieved concurrently with formation of the fine inorganic filler (B) through hydrolysis/condensation of a silicon-containing polymer having an organic matter moiety and an inorganic matter moiety. Specific process for producing this composite fine particle is similar to the process disclosed in, for example, JP-A-1999-5940 and the like.

The composite fine particle may include an organic polymer within the fine inorganic filler (B) that is a core. Accordingly, proper softness and toughness can be imparted to the fine inorganic filler (B).

An organic polymer having an alkoxy group may be preferably used as the above organic polymer. Content thereof is preferably 0.01 mmol or greater and 50 mmol or less per 1 g of the composite fine particle. Such an alkoxy group can enhance the affinity with a matrix resin that constitutes the binder 4, and improve dispersion property in the binder 4.

The alkoxy group herein implies an RO group bound to a metal element forming the fine particle skeleton. R herein represents an alkyl group which may be substituted, and the RO groups in the fine particles may be either the same or different. Specific examples of R include methyl, ethyl, n-propyl, isopropyl, n-butyl and the like.

Although percentage content of the organic polymer in the composite fine particle is not particularly limited, but the it is preferably equal to or greater than 0.5% by weight and equal to or less than 50% by weight on the basis of the fine inorganic filler (B).

It is preferred that a polyfunctional isocyanate compound and an ingredient having a hydroxyl group are included in the polymer composition. A crosslinking structure is formed between the polyfunctional isocyanate compound and the ingredient having a hydroxyl group. Consequently, moisture resistance and hardness as well as heat resistance of the optical sheet 1 are improved, and in addition, stability upon preservation, stain resistance, flexibility, weather resistance, solvent resistance and the like are also improved.

Specifically, (a) forms in which the organic polymer of the aforementioned composite fine particle has a hydroxyl group, and a polyfunctional isocyanate compound is further included in the polymer composition; and (b) forms in which the copolymer (A) has a hydroxyl group, and a polyfunctional isocyanate compound is further included in the polymer composition are available. Thus, the crosslinking reaction of the polymer composition is accelerated. Average hydroxyl value of the copolymer (A) having such a hydroxyl group is preferably 10 or greater and 200 or less, and particularly preferably 20 or greater and 100 or less. When the hydroxyl value of the copolymer (A) is less than the above range, crosslinking may be insufficient, and may result in unsatisfactory improvement of the aforementioned various characteristics such as moisture resistance and the like. To the contrary, when the hydroxyl value of the copolymer (A) is beyond the above range, the moisture resistance may be lowered.

Exemplary polyfunctional isocyanate compounds as described above may include aliphatic, alicyclic, aromatic and other polyfunctional isocyanate compounds, and modified compounds of the same. Specific examples of the polyfunctional isocyanate compound include e.g.,: trimers such as biuret bodies, isocyanurate bodies and the like of tolylene diisocyanate, xylylene diisocyanate, diphenylmethane diisocyanate, hexamethylene diisocyanate, isoholon diisocyanate, lysine diisocyanate, 2,2,4-trimethylhexylmethane diisocyanate, methylcyclohexane diisocyanate, 1,6-hexamethylene diisocyanate; compounds having two or more remaining isocyanate groups produced by a reaction of these polyfunctional isocyanates with a polyhydric alcohol such as propanediol, hexanediol, polyethyleneglycol, trimethylol propane or the like; blocked polyfunctional isocyanate compounds prepared by blocking these polyfunctional isocyanate compounds with a blocking agent e.g., alcohols such as ethanol, hexanol and the like, compounds having a phenolic hydroxyl group such as phenol, cresol and the like, oximes such as acetoxime, methylethylketoxime and the like, lactams such as ε-caprolactam, γ-caprolactam and the like; and the like. The polyfunctional isocyanate compound described above can be used alone or as a mixture of two or more thereof. Among them, non-yellowing polyfunctional isocyanate compounds without having an isocyanate group which directly binds to an aromatic ring are preferred in order to prevent the coated film from yellow discoloration.

When the aforementioned polyfunctional isocyanate compound is included, it is preferred that the polymer composition further contains a curing catalyst in order to promote the crosslinking reaction. Examples of the curing catalyst include tertiary amines such as triethylamine, triethylenediamine and the like; organic tin compounds such as dibutyl tin dilaurate, dibutyl tin diacetate, stannous octoate and the like. A catalytic promoter may be used in combination as needed.

Moreover, an antistatic property may be imparted to the optical sheet 1 by (a) a method to include an antistatic agent in the aforementioned polymer composition, or (b) a method in which an antistatic agent is coated on the outer face of the optical sheet 1. By thus imparting the antistatic property, attachment of dust and the like, and difficulties in superposing operation with the prism sheet and the like can be reduced.

The aforementioned antistatic agent is not particularly limited, and examples thereof which may be used include e.g., anionic antistatic agents such as alkyl sulfate, alkyl phosphate and the like; cationic antistatic agents such as quaternary ammonium salts, imidazoline compounds and the like; nonionic antistatic agents such as polyethyleneglycol based compounds, polyoxyethylene sorbitan monostearate esters, ethanolamides and the like; polymeric antistatic agents such as polyacrylic acid and the like; and the like. Among them, cationic antistatic agents are preferred which exhibit comparatively strong antistatic effects, and exert an excellent anti-static property also on the binder 4 in which a substrate polymer having high hydrophobicity is used. Moreover, among the cationic antistatic agents, ammonium salts and betaine are particularly preferably which can promote the antistatic property on the highly hydrophobic binder 4 as described above.

Additionally, other polymer, a plasticizer, a curing agent, a dispersant, any one of various leveling agents, an ultraviolet absorbing agent, an anti-oxidizing agent, a viscosity modifying agent, a lubricant, a light stabilizer and the like, for example, may be optionally blended in the polymer composition as needed. Examples of the other polymer include e.g., polyester resins, epoxy resins, fluorine resins, silicon resins, urethane resins, polyether resins, alkyd resins and the like.

Next, process for producing the optical sheet 1 is explained below. The process for producing the optical sheet 1 comprises: (a) a step of producing a coating liquid for an optical layer through admixing a light diffusing agent 5 with a polymer composition that constitutes a binder 4; and (b) a step of overlaying an optical layer 3 by applying the coating liquid for the optical layer onto a front face of a substrate layer 2 and drying. Solvent for use in the coating liquid for the optical layer may be selected ad libitum taking into account of solubility of each component of the polymer composition, operativity, cost and the like. This solvent is not particularly limited, but examples thereof include e.g., aromatic hydrocarbon based solvents such as toluene, xylene and the like; aliphatic hydrocarbon based solvents such as n-hexane, n-heptane and the like; ester based solvents such as ethyl acetate, n-butyl acetate and the like; ketone based solvents such as methyl ethyl ketone, methyl isobutyl ketone and the like; alcohol based solvents such as isopropyl alcohol, butyl alcohol and the like; and petroleum distillate in a variety of ranges of the boiling point containing aliphatic hydrocarbon as a principal component. The solvent may be used alone, or as a mixture of two or more. When crosslinking of isocyanate is carried out in the polymer composition, it is preferred that an alcohol based solvent is not used because a reaction between isocyanate and the alcohol based solvent is caused.

Because the optical sheet 1 contains the aforementioned copolymer (A) in the polymer composition that constitutes the binder 4, moisture resistance is elevated on behalf of the high hydrophobicity (water repellency, water resistance) of the binder 4 covering the surface thereof, thereby improving anti-bending property, dimensional stability and the like under a high temperature and high humidity condition. Additionally, basic performances of the coated film such as hardness, solvent resistance, whether resistance and the like of the optical layer 3 are improved. Moreover, dispersion of the fine inorganic filler (B) in the binder 4 can elevate the heat resistance of the optical layer 3, in turn, of the optical sheet 1. Accordingly, bending of the optical sheet 1 at high temperature and high humidity can be drastically suppressed in cooperation with the favorable moisture resistance.

An optical sheet 11 illustrated in FIG. 2 is constituted from a substrate layer 2, an optical layer 3 overlaid on the front side of this substrate layer 2, and a sticking preventive layer 12 overlaid on the back face of the substrate layer 2. Because the substrate layer 2 and the optical layer 3 are similar to those in the embodiment shown in FIG. 1, explanation thereof is omitted by way of assigning the identical numeric number. Accordingly, the optical sheet 11 also has elevated heat resistance and moisture resistance similarly to the optical sheet 1 as described above.

The sticking preventive layer 12 includes a binder 13, and beads 14 dispersed in this binder 13. This binder 13 is also formed by curing a polymer composition which is similar to that for the binder 4 of the optical layer 3 as described above (i.e., a polymer composition containing the copolymer (A) and the fine inorganic filler (B)). As the material for the beads 14, similar one to that for the light diffusing agent 5 in the optical layer 3 may be used. In addition, mean thickness of the sticking preventive layer 12 (mean thickness of a part where beads 14 are not present) is not particularly limited, but for example, it is set to be around equal to or greater than 1 μm and equal to or less than 10 μm.

The amount of the beads 14 to be blended is set to be a relatively small amount. The beads are dispersed in the binder 13 spacing apart with each other, and a small bottom part of many of the beads 14 are protruded from the binder 13. Therefore, when this optical sheet 11 is overlaid on the optical waveguide plate, the bottom edges of the protruded beads 14 are brought into contact with the surface of the optical waveguide plate or the like, and thus the entire surface of the back face of the optical sheet 11 is not brought into contact with the optical waveguide plate or the like. Sticking between the optical sheet 11 and the optical waveguide plate is thereby prevented, leading to suppression of the lack in uniformity of the brightness of the window of a liquid crystal display device.

Because the polymer composition constituting the binder 13 for the sticking preventive layer 12 also includes the copolymer (A) and the fine inorganic filler (B) according to the optical sheet 11, heat resistance and moisture resistance of the optical sheet 11 can be further improved, and the bending at high temperature and high humidity can be markedly suppressed.

Next, process for producing the optical sheet 11 is explained below. The process for producing the optical sheet 11 comprises: (a) a step of producing a coating liquid for an optical layer through admixing a light diffusing agent 5 with a polymer composition that constitutes a binder 4; (b) a step of overlaying an optical layer 3 by applying the coating liquid for the optical layer onto a front face of a substrate layer 2 and drying; (c) a step of producing a coating liquid for a sticking preventive layer through admixing beads 14 with a polymer composition that constitutes a binder 13; and (d) a step of overlaying a sticking preventive layer 12 by applying the coating liquid for the sticking preventive layer onto the back face of the substrate layer 2 and drying.

Therefore, when the optical sheet 1 or 11 of the present invention is used as a light diffusion sheet in a backlight unit for use in a liquid crystal display device equipped with: a lamp; an optical waveguide plate; a light diffusion sheet; a prism sheet and the like, where rays of light emitted from the lamp are diffused to lead to the front face side, bending, yellowing and the like are hardly caused even though it is exposed to generated heat from the lamp, external moisture and ultraviolet ray irradiation, because the optical sheet 1 or 11 has high heat resistance, moisture resistance, whether resistance and the like. Consequently, lack in uniformity of the brightness and lowering of the brightness of window of a liquid crystal display device can be suppressed.

### EXAMPLES

The present invention is explained in detail below based on Examples, however, the present invention should not be construed as being limited to the description of the Examples.

Synthesis of Copolymer (1)

Into a four-necked flask equipped with a stirrer, a thermometer, a cooling device, a dropping funnel and a tube for introducing a nitrogen gas, was charged n-butyl acetate (100 parts) as a solvent, and the temperature of which was elevated to a reflux temperature. Then, thereto was added dropwise a monomer mixture consisting of cyclohexyl methacrylate (40 parts), n-butyl methacrylate (37.7 parts), n-butyl acrylate (7.3 parts), 2-hydroxyethyl methacrylate (13.9 parts) and methacrylic acid (1.1 parts) as a monomer, and tert-butyl peroxy-2-ethyl hexanoate (“PERBUTYL O” manufactured by NOF CORPORATION; 3.0 parts) as a polymerization initiator, over 3 hrs from the dropping funnel while introducing a nitrogen gas. Further, thereto was added 1,1-bis(tert-butylperoxy)-3,3,5-trimethylcyclohexane (“PERHEXA 3M” manufactured by NOF CORPORATION; 0.2 part) three times at intervals of 30 min, which was kept at the reflux temperature for 2 hrs. Thereafter, the solution was cooled to room temperature to obtain a solution of a copolymer (1). In connection with the molecular weight of the copolymer (1), number average molecular weight (Mn)/weight average molecular weight (Mw) was 5300/10500.

Synthesis of Copolymers (2) to (11)

With a similar operation to that for the synthesis of the copolymer (1) described above except that monomer composition included in the monomer mixture was altered as shown in Table 1 below, solutions of copolymers (2) to (11) were obtained. Both of the copolymer (10) and copolymer (11) do not include any one of the cycloalkyl-containing recurring unit, the recurring unit derived from an iso-butyl (meth)acrylate and the recurring unit derived from a tert-butyl (meth)acrylate as a recurring unit.

TABLE 1

| Copolymer | (1) | (2) | (3) | (4) | (5) | (6) | (7) | (8) | (9) | (10) | (11) |
|---|---|---|---|---|---|---|---|---|---|---|---|
| CHMA | 40.0 | | | 40.0 | 50.0 | | | 40.0 | 40.0 | | |
| CHMMA | | | | | | 40.0 | | | | | |
| 4M-CHMMA | | | | | | | 40.0 | | | | |
| IBMA | | 40.0 | | | | | | | | | |
| TBMA | | | 40.0 | 20.0 | 20.0 | 20.0 | 20.0 | | 20.0 | | |
| MMA | | | | | | | | | | 37.2 | 40.0 |
| nBMA | 37.7 | 42.9 | 32.8 | 8.1 | 15.0 | 16.7 | 20.5 | 57.1 | 39.5 | 39.3 | 51.4 |
| BA | 7.3 | | | | | | | 2.4 | | | 8.1 |
| 2EHA | | 2.1 | 12.2 | 16.9 | | 8.3 | 4.5 | | | 8.5 | |
| HEMA | 13.9 | 13.9 | 13.9 | 13.9 | 13.9 | 13.9 | 13.9 | | | 13.9 | |
| MAA | 1.1 | 1.1 | 1.1 | 1.1 | 1.1 | 1.1 | 1.1 | 0.5 | 0.5 | 1.1 | 0.5 |
| Tg (° C.) | 40 | 40 | 40 | 40 | 74 | 40 | 40 | 40 | 61 | 40 | 40 |
| Theoretical | 60 | 60 | 60 | 60 | 60 | 60 | 60 | — | — | 60 | — |
| hydroxyl value | | | | | | | | | | | |

In Table 1 above, the following abbreviations are employed.
CHMA cyclohexyl methacrylate
CHMMA cyclohexylmethyl methacrylate
4M-CHMMA 4-methylcyclohexylmethyl methacrylate
IBMA iso-butyl methacrylate
TBMA tert-butyl methacrylate
MMA methyl methacrylate
nBMA n-butyl methacrylate
BA n-butyl acrylate
2EHA 2-ethylhexyl acrylate
HEMA 2-hydroxyethyl methacrylate
MAA methacrylic acid

Further, glass transition temperature (Tg) and theoretical hydroxyl value of each copolymer are presented in Table 1 in conjunction.

Glass Transition Temperature (Tg)

The glass transition temperature (Tg) of the copolymer was calculated according to the following Fox mathematical formula (1).

Mathematical Formula 1
1/Tg=Σ(Wn/Tgn)/100 (1)

In the above mathematical formula (1), Wn represents % by weight of a monomer n that is present in 100% by weight of the copolymer; and Tgn represents the glass transition temperature Tg (absolute temperature) of the homopolymer consisting of the monomer n.

Synthesis of Composite Fine Particle

According to the process described in JP-A-1999-5940, paragraphs [0056] to [0061], a dispersion including composite fine particles dispersed in n-butyl acetate was obtained. Concentration of the composite fine particles was 30.0% by weight, and content of the inorganic matter in the composite fine particles was 57.8% by weight. Mean particle size of the fine inorganic filler (B) that is a core of the composite fine particle was 55 nm, and coefficient of variation thereof was 18.0%. As an alkoxy group that is present in the composite fine particle, methoxy group was included in an amount of 0.12 mol/g. In addition, the composite fine particle was also excellent in time dependent stability. When a supernatant obtained by subjecting the composite fine particle dispersion to centrifugation was analyzed on GPC, organic polymer was not detected. Moreover, each composite fine particle which is a sediment following the centrifugation of the aforementioned composite fine particle dispersion was washed with THF or water, and the washing was analyzed on GPC, however, no organic polymer was detected. The results hereinabove demonstrate that the organic polymer of the composite fine particle is not merely adhered on the fine inorganic filler (B), but is rigidly fixed thereto.

In connection with the aforementioned composite fine particle dispersion, concentration of the composite fine particles in the dispersion, inorganic matter content in the composite fine particle, mean particle size of the fine inorganic filler (B) in the composite fine particle, coefficient of variation of the particle size of the fine inorganic filler (B), alkoxy group content in the composite fine particle, and time dependent stability were analyzed and evaluated according to the following methods.

Concentration of Composite Fine Particles

The concentration of the composite fine particles was determined after drying the composite fine particle dispersion under conditions of 100 mmHg, at 130° C. for 24 hrs, according the following mathematical formula (2).

Mathematical Formula 2
Concentration of composite fine particles (% by weight)=100×D/W (2)

In the above mathematical formula (2), D represents the weight (g) of the composite fine particle after drying, and W represents the weight (g) of the composite fine particle dispersion before drying.

Inorganic Matter Content in Composite Fine Particle

The inorganic matter content in the composite fine particle was determined from the ash content (wt %) through carrying out the elementary analysis for the dried composite fine particle dispersion under conditions of 100 mmHg, at 130° C. for 24 hrs.

Mean Particle Size of Fine Inorganic Filler (B) in Composite Fine Particle

The mean particle size of the fine inorganic filler (B) was measured at 23° C. by a dynamic light scattering measurement method. The measured mean particle size is a volume average particle size. Submicron particle size analyzer (“NICOMP MODEL 370” manufactured by Nozaki Ltd.,) was used as a measuring device, and as a sample for the measurement, a composite fine particle dispersion having a concentration of the composite fine particles of 0.1 to 2.0% by weight which had been dispersed in tetrahydrofuran (when the organic polymer in the composite fine particle is not dissolved in tetrahydrofuran, a dispersion obtained by allowing dispersion in a solvent in which the organic polymer is dissolved) was used.

Coefficient of Variation of Fine Inorganic Filler (B)

The coefficient of variation (%) of the particle size of the fine inorganic filler (B) was calculated according to the following mathematical formula (3).

$$[ Mathematical formula 3 ] \\ Coefficient of variation ( \% ) = \frac{Standard deviation of particle size of fine inorganic filler}{Mean particle size of fine inorganic filler} \qquad ( 3 )$$

Alkoxy Group Content in Composite Fine Particle

The alkoxy group content in the composite fine particle was measured by dispersing 5 g of a dried composite fine particle dispersion under conditions of 100 mmHg, at 130° C. for 24 hrs in a mixture of 50 g of acetone and 50 g of a 2 N aqueous NaOH solution, stirring at room temperature for 24 hrs, followed by determination of the alcohol in this fluid with a gas chromatography apparatus.

Time Dependent Stability

The composite fine particle dispersion was placed to seal in a Gardner viscosity tube, and stored at 50° C. One month later, evaluation was made to determine ones with no aggregation, precipitation of particles and increase in viscosity found as “favorable”.

### Example 1

A dispersion of composite fine particle A including a fine inorganic filler in n-butyl acetate, and a solution of the copolymer (1) were prepared, and mixed to give an inorganic matter content in the solid content (fine inorganic filler content) of 40% by weight. Accordingly, a polymer composition containing the copolymer (1) and the composite fine particles was obtained. To this polymer composition were blended 100 parts (amount calculated on the basis of the solid content per 100 parts of the copolymer) of acrylic resin beads (“MBX-5” manufactured by Sekisui Plastics Co., Ltd.) having a mean particle size of 5 μm as a light diffusing agent, and thereto was further blended polyfunctional isocyanate (“Coronate HX” manufactured by NIPPON POLYURETHANE INDUSTRY CO., LTD.) after weighing to give an amount yielding OH group/NCO group of 1 (equivalent ratio). Thus resulting coating liquid for an optical layer was applied on a polyethylene terephthalate film (substrate layer) having a thickness of 100 μm using a bar coater to give an average film thickness after drying of 15 μm. After leaving to stand at room temperature for 1 hour, the coated substrate layer was subjected to forced drying at 80° C. for 2 hrs, thereby completing an optical sheet according to Example 1.

Surface hardness, transmittance of entire rays of light, haze, brightness, heat resistance and moisture resistance of thus obtained optical sheet according to Example 1 were measured for evaluation. The results are shown in the following Table 2. Method of measurement and evaluation of each physical property is as described below.

Surface Hardness

A coating liquid was prepared in a similar manner to that in Example 1 except that the light diffusing agent was not used, and this coating liquid was applied on a steel sheet treated with zinc phosphate having a thickness of 0.3 mm using a bar coater to give a film thickness after drying of 15 μm. After leaving to stand at room temperature for 1 hour, the coated steel sheet was subjected to forced drying at 80° C. for 2 hrs, thereby completing a sample specimen. Pencil scratch test defined in JIS-K5400-1900, 8.4.1 (testing machine method) was conducted for this sample specimen, and the pencil hardness upon getting scratched on the coated film was estimated as the surface hardness.

Transmittance of Entire Rays of Light, Haze

Transmittance of entire rays of light and haze were measured according to JIS-K-7105-5.5 (A method), using HZ-2 available from SUGA TEST INSTRUMENTS Co., Ltd.

Brightness

Face brightness was measured after overlaying the optical sheet on the upper face of the optical waveguide plate of an edge light type backlight, using Luminance Colorimeter BM-7 manufactured by TOPCON CORPORATION.

Evaluation of Heat Resistance

A backlight unit having an optical sheet incorporated therein was manufactured. This backlight unit was placed in a thermostatic chamber at 60° C. After the placing, time point when bending of the optical sheet occurs was measured. Presence of the bending of the optical sheet was determined on the basis of occurrence of the lack in uniformity of the brightness through turning on the lamp of the backlight unit.

Evaluation of Moisture Resistance

The optical sheet was attached on an aluminum plate having a thickness of 0.8 mm such that the coated surface faces upward, and left to stand in an atmosphere of at 50° C. and relative humidity of 98% for 3 days. Then, the optical sheet was visually observed, and evaluation was made as (1) “o” for the absence of any alteration, and (2) “x” for the presence of abnormal appearance such as whitening and bulge.

### Examples 2 to 7

Optical sheets of Examples 2 to 7 were produced using copolymers (2) to (7) shown in Table 1 as a copolymer. Fundamental procedures for producing these optical sheets conformed to the aforementioned Example 1 (The same is applied to in the followings). Conditions for producing these optical sheets and results of evaluation are shown in Table 2.

### Examples 8 to 9

Optical sheets of Examples 8 and 9 were produced using colloidal silica (“SNOWTEX®” manufactured by Nissan Chemical Industries, Ltd.) B having a mean particle size of 15 nm as a fine inorganic filler. Conditions for producing these optical sheets and results of evaluation are shown in Table 2.

### Examples 10 to 11

Optical sheets of Examples 10 and 11 were produced without adding any polyfunctional isocyanate compound. Conditions for producing these optical sheets and results of evaluation are shown in Table 2.

### Examples 12 to 13

Optical sheets of Examples 12 and 13 were produced using block isocyanate (“Desmodule BL-3370 MPA” manufactured by Sumika Bayer Urethane) in stead of polyfunctional isocyanate. Further, the condition for drying was changed to: leaving to stand at room temperature for 1 hour followed by forced drying at 100° C. for 1 hour. Conditions for producing these optical sheets and results of evaluation are shown in Table 3.

### Examples 14 to 15

In a similar manner to Example 1 described above except that the inorganic matter content was changed, optical sheets of Examples 14 and 15 were produced. Conditions for producing these optical sheets and results of evaluation are shown in Table 3.

### Comparative Example 1

Optical sheet of Comparative Example 1 was produced using the copolymer (10) shown in Table 1 as a copolymer. Conditions for the production and results of evaluation are shown in Table 3.

### Comparative Example 2

Optical sheet of Comparative Example 2 was produced without blending fine inorganic filler. Conditions for the production and results of evaluation are shown in Table 3.

### Comparative Example 3

Optical sheet of Comparative Example 3 was produced using the copolymer (11) shown in Table 1 as a copolymer, and without adding any polyfunctional isocyanate compound. Conditions for the production and results of evaluation are shown in Table 3.

### Comparative Examples 4 to 5

Optical sheets of Comparative Examples 4 and 5 were produced without blending any fine inorganic filler. Conditions for the production and results of evaluation are shown in Table 3.

### Comparative Example 6

Optical sheet of Comparative Example 6 was produced without blending any fine inorganic filler and polyfunctional isocyanate compound. Conditions for the production and results of evaluation are shown in Table 3.

TABLE 2

| | | | | | | | | | | Exam- | Exam- |
|---|---|---|---|---|---|---|---|---|---|---|---|
| | Example 1 | Example 2 | Example 3 | Example 4 | Example 5 | Example 6 | Example 7 | Example 8 | Example 9 | ple 10 | ple 11 |
| Copolymer | (1) | (2) | (3) | (4) | (5) | (6) | (7) | (1) | (7) | (8) | (9) |
| Fine inorganic | A | A | A | A | A | A | A | B | B | A | A |
| filler | | | | | | | | | | | |
| Inorganic matter | 40 | 40 | 40 | 40 | 40 | 40 | 40 | 40 | 40 | 40 | 40 |
| Content (wt %) | | | | | | | | | | | |
| Isocyanate compound | NCO | NCO | NCO | NCO | NCO | NCO | NCO | NCO | NCO | Absent | Absent |
| Surface hardness | 2H | 2H | 2H | 3H | 3H | 3H | 3H | 2H | 3H | 2H | 2H |
| Transmittance of | 71 | 74 | 71 | 73 | 70 | 71 | 70 | 70 | 71 | 71 | 70 |
| entire light (%) | | | | | | | | | | | |
| Haze (%) | 88 | 87 | 88 | 88 | 89 | 86 | 88 | 90 | 88 | 87 | 87 |
| Brightness (cd/m²) | 1268 | 1270 | 1267 | 1263 | 1260 | 1261 | 1255 | 1232 | 1228 | 1225 | 1220 |
| Heat resistance | 120≦ | 120≦ | 120≦ | 120≦ | 120≦ | 120≦ | 120≦ | 120≦ | 120≦ | 96 | 96 |
| Moisture resistance | ◯ | ◯ | ◯ | ◯ | ◯ | ◯ | ◯ | ◯ | ◯ | X | X |

TABLE 3

| | Example | Exam- | Exam- | Exam- | Comparative | Comparative | Comparative | Comparative | Comparative | Comparative |
|---|---|---|---|---|---|---|---|---|---|---|
| | 12 | ple13 | ple 14 | ple 15 | Example 1 | Example 2 | Example 3 | Example 4 | Example 5 | Example 6 |
| Copolymer | (1) | (5) | (1) | (1) | (10) | (10) | (11) | (4) | (5) | (8) |
| Fine inorganic | A | A | A | A | A | Absent | A | Absent | Absent | Absent |
| Filler | | | | | | | | | | |
| Inorganic matter | 40 | 40 | 30 | 20 | 40 | 40 | 40 | 40 | 40 | 40 |
| Content (wt %) | | | | | | | | | | |
| Isocyanate compound | BNCO | BNCO | NCO | NCO | NCO | NCO | Absent | NCO | NCO | Absent |
| Surface hardness | H | 2H | 2H | H | 2H | HB | 2H | HB | F | HB |
| Transmittance of | 72 | 71 | 73 | 74 | 74 | 75 | 73 | 70 | 71 | 71 |
| entire light (%) | | | | | | | | | | |
| Haze (%) | 88 | 88 | 88 | 86 | 87 | 86 | 86 | 86 | 87 | 88 |
| Brightness (cd/m²) | 1266 | 1259 | 1275 | 1278 | 1278 | 1280 | 1275 | 1273 | 1271 | 1270 |
| Heat resistance | 120≦ | 120≦ | 120≦ | 96 | 72 | 24 | 72 | 48 | 72 | 48 |
| Moisture resistance | ◯ | ◯ | ◯ | ◯ | X | X | X | X | X | X |

As shown in Table 2 and Table 3 above, the optical sheets of Examples 1 to 15 have more excellent various characteristics such as heat resistance, moisture resistance and the like compared to the optical sheets of Comparative Examples 1 to 6.

1. An optical sheet which comprises a transparent substrate layer, and an optical layer overlaid to the front face side of the substrate layer,
wherein the optical layer comprises a binder,
the binder is formed from a polymer composition comprising (A) a copolymer and (B) a fine inorganic filler, and
the copolymer (A) comprises at least one of a recurring unit derived from a (meth)acrylic ester having a cycloalkyl group, a recurring unit derived from an iso-butyl (meth)acrylate or a recurring unit derived from a tert-butyl (meth)acrylate.

2. The optical sheet according to claim 1 wherein a light diffusing agent is included in said binder.

3. The optical sheet according to claim 1 further comprising a sticking preventive layer overlaid to the back face side of said substrate layer,
wherein the sticking preventive layer contains beads in a binder,
the binder is formed from said polymer composition.

4. The optical sheet according to claim 1 wherein said recurring unit derived from a (meth)acrylic ester having a cycloalkyl group is represented by the following Chemical formula (1): 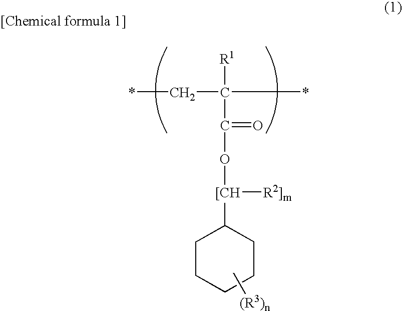
In the above chemical formula (1), R¹ represents a hydrogen atom or a methyl group; R² represents a hydrogen atom, a methyl group or an ethyl group; R³ represents an organic residue; m represents an integer number of 0 or greater and 4 or less; and n represents an integer number of 0 or greater and 2 or less. When m is equal to or greater than 2, R² may be the same or different; and when n is equal to or greater than 2, R³ may be the same or different.

5. The optical sheet according to claim 1 wherein mean particle size of said fine inorganic filler (B) is 5 nm or greater and 200 nm or less.

6. The optical sheet according to claim 1 wherein coefficient of variation of the particle size of said fine inorganic filler (B) is equal to or less than 50%.

7. The optical sheet according to claim 1 wherein colloidal silica is used as said fine inorganic filler (B).

8. The optical sheet according to claim 1 wherein an organic polymer is fixed on the surface of said fine inorganic filler (B).

9. The optical sheet according to claim 8 wherein said organic polymer has a hydroxyl group, and a polyfunctional isocyanate compound is further included in the polymer composition.

10. The optical sheet according to claim 1 wherein said copolymer (A) has a hydroxyl group, and a polyfunctional isocyanate compound is further included in the polymer composition.

11. The optical sheet according to claim 2 wherein mean particle size of said light diffusing agent is 1 μm or greater and 50 μm or less.

12. In a backlight unit, which comprises an optical sheet, for use in a liquid crystal display device in which rays of light are diffused to lead to the front face side,
said optical sheet comprising a transparent substrate layer, and an optical layer overlaid to the front face side of the substrate layer,
the optical layer including a binder,
the binder being formed from a polymer composition comprising (A) a copolymer and (B) a fine inorganic filler,
the copolymer (A) comprising at least one of a recurring unit derived from a (meth)acrylic ester having a cycloalkyl group, a recurring unit derived from an iso-butyl (meth)acrylate or a recurring unit derived from a tert-butyl (meth)acrylate.
